(19) United States
(12) Patent Application Publication
(10) Pub. No.: US 2026/0277761 A1
(43) Pub. Date: Sep. 17, 2026

(54) DOMAIN-BASED QUALITY MANAGEMENT

(71) Applicant: Honeywell International Inc., Charlotte, NC (US)

(72) Inventors: Ankit Singh, Apex, NC (US); Lakshminarayana Paila, Frisco, TX (US); Zillery Fortner, Burlington, KY (US); Judith Fainor, Doylestown, PA (US); Stephen McCarthy, Concord, NC (US)

(21) Appl. No.: 19/017,815

(22) Filed: Jan. 13, 2025

(51) Int. Cl. G06F 11/30; G06F 11/32; G06F 16/2452

(52) U.S. Cl. CPC G06F 11/3034; G06F 11/324; G06F 16/24528; G06F 2201/80; G06F 2201/805

(57) ABSTRACT

Techniques for domain-based quality management are disclosed. A domain-specific data to assess quality thereof is received and processed using the analysis model. One of a plurality of standardized domain-specific data framework that is to correspond to the domain-specific data is identified using the analysis model. Each of a plurality of fields of the domain-specific data is mapped with a field of the first plurality of fields of the identified standardized domain-specific data framework using the analysis model. Critical quality control factors are monitored using the analysis model. Alerts are generated in response to the monitoring. Customized visualizations and predictive analytics are displayed based on the monitoring.

### BACKGROUND

Traditionally, industries, such as pharmaceutical industry, medical devices industry, aerospace industry, semiconductor industry, manufacturing industry, healthcare industry, food and beverage manufacturing industry, and the like, emphasize on quality management of the products. Generally, the emphasis on the quality management is not only based on a business decision. Instead, it is also to adhere to a regulatory requirement. For instance, in a drug manufacturing industry, some quality parameters, such as drug concentration, dissolution rate, and the like, may have to be adhered to get approval from a regulatory body. This is done to ensure consumers'safety. Conventionally, the process of quality management relied heavily on end-product testing and inspection. However, this approach often led to high costs due to product rejections, rework, and redesign. Such a process also provided limited insights into the root causes of quality issues.

To overcome such issues, in the recent years, industries have sought to adopt Quality by Design (QbD) approach. The QbD approach aims to build quality into products and processes from the outset rather than testing at the end. QbD relies on identifying critical quality attributes (CQAs) and critical process parameters (CPPs) that impact product quality. CQAs are properties, such as physical, chemical, biological, or microbiological, and the like, or characteristics that should be within a predefined range, to ensure the desired product quality. For instance, in a drug manufacturing industry, the dissolution rate of the drug is a CQA as it directly impacts the bioavailability of the drug. The CPPs are variables or parameters that have a direct and significant impact on CQAs when varied within a predetermined range. For example, in a semiconductor manufacturing, the CPPs for creating circuit patterns in silicon wafers include exposure dose, humidity, and the like.

### SUMMARY

In the present subject matter, a system for domain-based quality management may include a processing unit. The processing unit may maintain, using an analysis model, a plurality of standardized domain-specific data framework in a repository. Each domain-specific data framework may correspond to a field of operation. The field of operation may correspond to an industry, such as pharmaceutical industry, medical device industry, aerospace industry, semiconductor industry, automotive industry, manufacturing industry, retail industry, healthcare industry, and the like. Each of the plurality of domain-specific data framework may include a first plurality of fields. Each field of the first plurality of fields corresponding to a quality management parameter. Each of the plurality of standardized domain-specific data framework may be updateable. The processing unit may receive a domain-specific data to assess quality corresponding to the domain-specific data. The domain-specific data may correspond to a field of operation. The domain-specific data may include a second plurality of fields. Each of the second plurality of fields may correspond to a quality management parameter. The analysis model may be, for example, a machine-learning model. The analysis model may be trainable on a plurality of historical domain-specific data to build each of the plurality of standardized domain-specific data frameworks. For the building, the analysis model may identify common fields and attributes across the plurality of historical domain-specific data. The processing unit may process, using the analysis model, the received domain-specific data.

Further, the processing unit may identify, using the analysis model, one of the plurality of standardized domain-specific data framework that is to correspond to the domain-specific data based on the processing. The processing unit may map, using the analysis model, each of the second plurality of fields of the domain-specific data with a field of the first plurality of fields of the identified standardized domain-specific data framework. The processing unit may monitor, using the analysis model, critical quality control factors in response to the mapping. The critical quality control factors may include measurable characteristics that impact quality corresponding to the domain-specific data. The processing unit may generate, using the analysis model, alerts corresponding to the critical quality control factors in response to the monitoring. The processing unit may display customized visualizations and predictive analytics based on the monitoring. The visualizations may include interactive dashboards are dynamically updated based on real-time data.

In an example, the processing unit may detect, using the analysis model, anomalies based on the monitoring of the critical quality control factors. The processing unit may generate, using the analysis model, the alerts corresponding to the critical quality control factors in response to the detection. In an example, the processing unit may provide, using the analysis model, recommendations corresponding to the domain-specific data for addition of fields to the second plurality of fields for the mapping to assess quality. In a further example, the processing unit may receive, from a user, inputs corresponding to manual mapping of each of the second plurality of fields of the domain-specific data with a field of the first plurality of fields of the identified standardized domain-specific data framework. Further, the processing unit may map, using the analysis model, each of the second plurality of fields of the domain-specific data with a field of the first plurality of fields of the identified standardized domain-specific data framework based on the received inputs.

The processing unit may detect, using the analysis model, a field being mapped by the user based on the inputs. Further, the processing unit may recommend, using the analysis model, a predefined domain-specific definition to the user in case of the mapping being not in accordance with the definition corresponding to the field.

For the processing, the processing unit may extract, using the analysis model, metadata from the domain-specific data and may compare, using the analysis model, the extracted metadata with metadata corresponding to each of the plurality of domain-specific data framework. Prior to the monitoring of the critical quality control factors, the processing unit may ascertain, using the analysis model, at least one of the second plurality of fields does not correspond to each of the first plurality of fields based on the mapping. Further, the processing unit may update, using the analysis model, the identified standardized domain-specific data framework to include a custom field corresponding to the identified at least one of the second plurality of fields.

In an example, the processing unit may receive, from a user, inputs corresponding to manual mapping of each of the second plurality of fields of the domain-specific data with a field of the first plurality of fields of the identified standardized domain-specific data framework. The processing unit may map, using the analysis model, each of the second plurality of fields of the domain-specific data with a field of the first plurality of fields of the identified standardized domain-specific data framework based on the received inputs. The processing unit may update, using the analysis model, the standardized domain-specific data framework. In another example, the processing unit may receive, from a user, a request to add a custom field upon the mapping of the each of the second plurality of fields. The processing unit may update, using the analysis model, the identified standardized domain-specific data framework to include the custom field.

In an example, the method for domain-based quality management may include accessing, by a processing unit, a repository for a plurality of standardized domain-specific data framework. Each domain-specific data framework may correspond to a field of operation. Each of the plurality of domain-specific data frameworks may include a first plurality of fields. Each field of the first plurality of fields may correspond to a quality management parameter. Each of the plurality of standardized domain-specific data frameworks may be updateable. A domain-specific data may be received to assess quality corresponding to the domain-specific data. The domain-specific data may correspond to a field of operation. The domain-specific data may include a second plurality of fields. Each of the second plurality of fields may correspond to a quality management parameter. The received domain-specific data may be processed by the processing unit by using an analysis model. A standardized domain-specific data framework from the plurality of standardized domain-specific data frameworks may be identified by the processing unit using the analysis model based on the processing. The identified standardized domain-specific data framework may correspond to the domain-specific data. Each of the second plurality of fields of the domain-specific data may be mapped, by the processing unit, with a field of the first plurality of fields of the identified standardized domain-specific data framework using the analysis model.

A first set of the second plurality of fields that do not correspond to each of the first plurality of fields may be ascertained, by the processing unit, using the analysis model, based on the mapping. The method may include adding, by the processing unit, a plurality of custom fields corresponding to the plurality of the second plurality of fields to the identified standardized domain-specific data framework using the analysis model. The method may include monitoring, by the processing unit, critical quality control factors in real-time based on the mapping and the adding of the plurality of custom fields. The critical quality control factors may include measurable characteristics that impact quality corresponding to the domain-specific data. Based on the monitoring, alerts to the user using the analysis model, analysis and visualization, and/or quality management workflows may be generated by the processing unit. The analysis may include insights regarding quality corresponding to the domain-specific data in real-time. The visualization may include interactive dashboards corresponding to the domain-specific data in real-time. The quality management workflows may include update of records in an integrated quality management system corresponding to the domain-specific data.

In an example, a non-transitory computer-readable medium may include instructions for domain-based quality management. The instructions may be executable by the processing resource to receive a plurality of historical domain-specific data. Each of the plurality of historical domain-specific data may correspond to a field of operation. Each of the plurality of historical domain-specific data may include a plurality of attributes. Each attribute may correspond to a quality management parameter. An analysis model may be trained on the plurality of historical domain-specific data. The training may include identifying, using the analysis model, common attributes corresponding to the plurality of historical domain-specific data. Further, the training may include generating, using the analysis model, a plurality of standardized domain-specific data framework. Each domain-specific data framework may correspond to a field of operation. Each of the plurality of domain-specific data frameworks may include a first plurality of fields. Each field of the first plurality of fields may correspond to a quality management parameter. Each of the plurality of standardized domain-specific data frameworks may be updateable. The instructions may be executable by the processing resource to store the plurality of standardized domain-specific data framework in a repository.

A domain-specific data may be received to assess quality corresponding to the domain-specific data. The domain-specific data may correspond to a field of operation. The domain-specific data may include a second plurality of fields. Each of the second plurality of fields may correspond to a quality management parameter. The instructions may be executable by the processing resource to process the received domain-specific data using the analysis model and access the plurality of standardized domain-specific data framework. The instructions may be executable by the processing resource to identify a standardized domain-specific data framework from the plurality of standardized domain-specific data frameworks upon the accessing using the analysis model. The identified standardized domain-specific data framework may correspond to the domain-specific data. Further, the instructions may be executable by the processing resource to map each of the second plurality of fields of the domain-specific data with a field of the first plurality of fields of the identified standardized domain-specific data framework using the analysis model by either manually or automatically.

The instructions may be executable by the processing resources to determine critical quality control factors using the analysis model based on the mapping. The critical quality control factors may include measurable characteristics that impact quality corresponding to the domain-specific data. The critical quality control factors may be monitored in real-time upon the determination. The instructions may be executable by the processing resource to perform notification to a user regarding the quality corresponding to the domain-specific data based on the monitoring and/or generating analysis and visualization for displaying to the user. The analysis may include insights regarding quality corresponding to the domain-specific data in real-time. The visualization may include interactive dashboards corresponding to the domain-specific data in real-time.

### BRIEF DESCRIPTION OF DRAWINGS

The detailed description is provided with reference to the accompanying figures. In the figures, the left-most digit(s) of a reference number identifies the figure in which the reference number first appears. The same numbers are used throughout the drawings to reference like features and components.

FIG. 1 illustrates a system for domain-based quality management, according to an example implementation of the present subject matter.

FIG. 2 illustrates a system for domain-based quality management, according to an example implementation of the present subject matter.

FIG. 3 illustrates a system for domain-based quality management, according to an example implementation of the present subject matter.

FIGS. 4a-4b illustrate a method for domain-based quality management, according to an example implementation of the present subject matter.

FIG. 5 illustrates a method for domain-based quality management, according to an example implementation of the present subject matter.

FIG. 6 illustrates a method for mapping in domain-based quality management, according to an example implementation of the present subject matter.

FIGS. 7a-7b illustrate a method for domain-based quality management, according to an example implementation of the present subject matter and

FIGS. 8a-8b illustrate a computing environment, implementing a non-transitory computer-readable medium for domain-based quality management, according to an example implementation of the present subject matter.

### DETAILED DESCRIPTION

Generally, industries, such as pharmaceutical industry, medical devices industry, aerospace industry, semiconductor industry, manufacturing industry, healthcare industry, food and beverage manufacturing industry, and the like, emphasize on quality management of the products. Accordingly, in the recent years, industries have sought to adopt Quality by Design (QbD) approach. The QbD approach relies on identifying critical quality attributes (CQAs) and critical process parameters (CPPs) that impact product quality.

The understanding of relationship between CPPs and CQAs provides real-time monitoring and control of critical parameters, predictive modelling of quality output, and proactive quality management. Similarly, Continuous process verification (CPV) involves ongoing monitoring of manufacturing processes to ensure they remain in a state of control. The use of QbD approach through CPV is one of the important things in designing robust processes that produce high-quality products.

Traditionally, different systems, such as Manufacturing Execution Systems (MES), Track and Trace solutions, Quality Management Systems (QMS), and the like, in the industries have operated in silos. Further, the systems have limited integration between different applications and data sources. This siloed approach has made it challenging to gain a holistic view of quality across the entire product lifecycle. The implementation of QbD requires integrating data from multiple disparate systems. However, because of the siloed approach, the implementation of the QbD remains challenging. Identifying and managing the relationships between CPPs and CQAs across complex manufacturing processes remains a significant challenge in many industries due to this limited interaction between different systems.

Conventionally, there exists an inability to use real-time data for continuous process verification. For instance, in biopharmaceutical manufacturing, critical process parameters like temperature, pH, and dissolved oxygen levels directly impact product quality. However, monitoring these parameters in real-time and correlating them with quality outcomes remains a challenge for many organizations.

Currently, quality management approaches to integrate data between various systems require significant manual effort to classify and map the data model. Further, in particular, such integration of data is customer specific and is not industry specific. In other words, current approaches require each customer to define their own data models when onboarding to quality management systems. This leads to inconsistent data structures across an industry. This is because different organizations within the same industry define and measure quality differently. Therefore, the current approach of integration of data for quality management processes are different. The lack of standardization makes it difficult to benchmark performance and share best practices across the industry. For example, two pharmaceutical companies may use different data models to represent a medication: Company A: (ID, Name, Description) and Company B: (ID, Name, Description, Drug_Class). This variation makes it complex to create industry-wide quality standards and complicates efforts to analyze quality trends across multiple organizations. Further, across industries, such a manual effort of integration of data into quality management systems may be a duplicated effort as similar companies may recreate similar data models.

Further, as industries evolve and new technologies emerge, the definition of quality and the parameters that influence it continue to change. For example, in the food and beverage industry, changing consumer preferences are driving new quality considerations around ingredients, nutritional content, and sustainability. Existing quality management approaches often struggle to adapt to these evolving requirements, as they are typically based on static models and predefined parameters.

In addition, without integrated, real-time data across systems, it may be difficult to detect manufacturing anomalies early. Similarly, it may be difficult to correlate process parameters with quality outcomes and take preventive action before quality issues occur. For example, a food manufacturer may not realize a slight temperature deviation in one process step is correlated with increased microbial contamination until after product release, leading to recalls in the product. Accordingly, the existing approaches do not alert when there is a deviation in CPP or in CPA or provide predictive analytics of quality parameters. Therefore, with the existing approaches, it is difficult to adopt QbD through continuous process verification.

The present subject matter relates to techniques for domain-based quality management applicable across various industries. The techniques allow generation of standardized domain-specific data frameworks through a training process. For instance, a plurality of historical domain-specific data may be used to train an analysis model. Each historical domain-specific data may correspond to a field of operation. For instance, a first set of historical domain-specific data may correspond to the drug industry, a second plurality of historical domain-specific data may correspond to medical device industry, and the like. The historical domain-specific data may include various attributes related to quality management parameters. For instance, each of the first set of historical domain-specific data may include a name of the drug formulation, strength of the drug formulation, temperature during formulation, temperature during mixing processes, and the like. The analysis model may be a machine-learning based model and may be updateable. In an example, the analysis model may be, for example, a Large Language Model and may be fine-tuned based on the field of operation.

During the training process, the analysis model may identify common attributes across the historical domain-specific data and may generate a set of standardized domain-specific data frameworks. Accordingly, each framework corresponds to a specific field of operation and may include fields representing quality management parameters. For instance, a first standardized domain-specific data framework may correspond to drug industry, a second standardized domain-specific data framework may correspond to medical device industry, and the like. The generated domain-specific data frameworks may be stored in a repository.

When new domain-specific data is received for integration thereof for quality assessment, the trained analysis model processes this information. For the processing, meta data corresponding to the new domain-specific data may be extracted and may be compared with meta data corresponding to the standardized domain-specific data frameworks. Based on the comparison, the appropriate standardized framework from the repository may be identified. Subsequently, the incoming data fields may be mapped to this framework. This process can be automated or may involve user input for manual mapping. In addition, the system may also provide appropriate guidance to assist users during mapping by providing standard definition for the data fields.

Further, the system may provide guidance and recommendations to correct any mapping errors. In an example, when incoming data fields don't correspond to existing framework fields, the analysis model can be updated the standardized framework to include custom fields, ensuring comprehensive quality management. The adaptability of the analysis model allows refining frameworks based on new data, allowing it to evolve as industry standards and quality parameters change. In some examples, the techniques also provide recommendations to include additional fields for quality assessment based on the domain knowledge.

The system monitors critical quality control factors in real-time based on the mapping. In particular, the system monitors Critical Process Parameters (CPPs) and Critical Quality Attributes (CQAs), which are compared against predefined thresholds. These thresholds can be set by the user or can be provided by the analysis model based on the domain knowledge. When deviations from the thresholds occur, anomalies may be detected. In such scenarios, alerts may be generated. Further, based on the anomalies, quality management workflows may be generated. The quality management workflows may include update of records in an integrated QMS, notifying a quality personnel to address one or more quality issues, and the like.

In addition, customized visualizations and predictive analytics may be generated based on the real-time data. The customized visualizations may include interactive dashboards that update in real-time based on real-time data. Further, insights regarding quality and can update records in integrated quality management systems.

With the present subject matter, standardized domain-specific data frameworks for various industries are generated. The various industries are, for examples, pharmaceutical industry, biotechnology industry, medical devices industry, healthcare industry, aerospace industry, forensic industry, retail industry, semiconductor industry, and the like. In the present subject matter, an analysis model that is updateable and that is trainable, is used. The present subject matter provides continuous learning from new data, improving the ability to detect anomalies using continuous process verification and predict quality issues over time. The present subject matter enables real-time monitoring of CPPs and CQAs and enables early detection of potential quality issues.

The present subject matter provides comprehensive alerts and notifications regarding quality issues. In addition, the present subject matter also provides predictive analytics regarding quality issues over time. Therefore, the present subject matter enables proactive quality management instead of reactive quality management and thereby, preventing issues before they occur. Accordingly, with the present subject matter enables adopting QbD approach through continuous process verification. With the present subject matter, manual effort required for integration of data models is reduced. In other words, the present subject matter allows automatic mapping of customer's data models into the system. In addition, with the present subject matter, the option of manual addition of custom attributes to monitor quality parameters is also allowed. Therefore, the present subject matter provides user customization to monitor quality parameters. Further, the present subject matter provides recommendations to the user and enables the user to select appropriate attributes for mapping. The present subject matter provides a holistic view of quality across the product lifecycle, enabling better decision-making and continuous improvement.

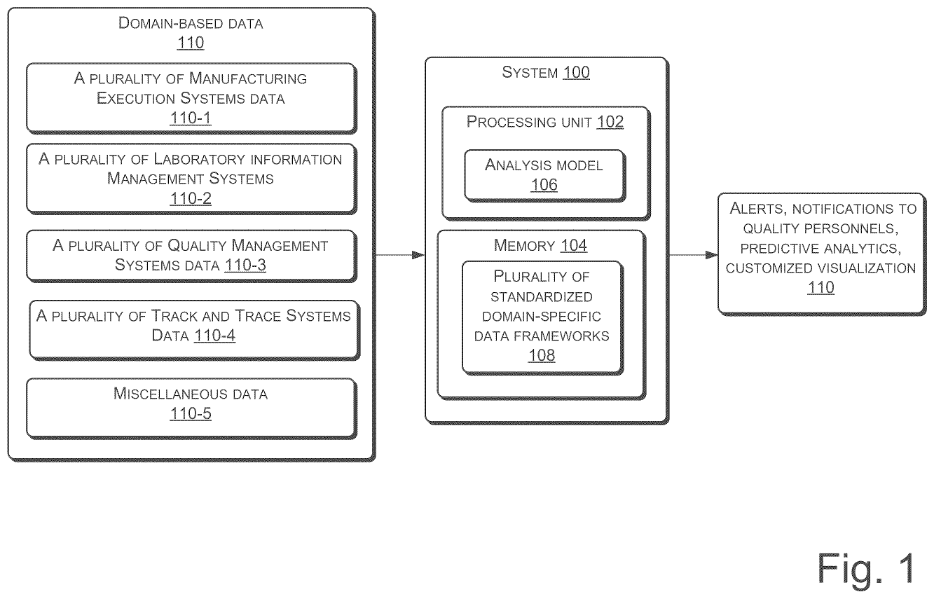

The present subject matter is further described with reference to FIGS. 1-8b. It should be noted that the description and figures merely illustrate principles of the present subject matter. Various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

FIG. 1 illustrates a system 100 for domain-based quality management, according to an example implementation of the present subject matter. The domain-based data 110 may include data from a set of systems, as is illustrated in FIG. 1. Each of the domain-based data 110 may correspond to a field of operation, such as an industry. For instance, the domain-based data may include pharmaceutical industry, aerospace industry, semiconductor industry, automotive industry, manufacturing industry, retail industry, healthcare industry, bio-technology industry, food and beverage industry, and the like. The domain-specific data 110 may be collected at all stages of lifecycle of a product, such as supply, clinical research, manufacturing, and quality review and approvals. Accordingly, in an example, the domain-based data 110 may include a plurality of manufacturing execution systems (MES) data 110-1, a plurality of Laboratory Information Management systems (LIMS) data 110-2, a plurality of Quality Management Systems (QMS) data 110-3, a plurality of track and trace systems data 110-4, and miscellaneous data 110-5.

The plurality of MES data 110-1 may include data from Manufacturing Excellence Program (MxP) MES, pharmaceutical MES, aerospace MES, semiconductor MES, automotive MES, manufacturing Enterprise Resource Planning (ERP), retail ERP, health care ERP, food and beverage MES. Each of these domain-specific data 110 may include various data about products made in the corresponding MES or products handled by corresponding ERP. For instance, a pharmaceutical MES data may include data about manufacturing of a drug, such as name of the drug, composition of the drug, strength of the drug, classification of the drug, and the like. Similarly, the automotive MEP data may include data about type of vehicle, engine used in vehicle, process parameters corresponding to manufacturing of vehicle, and the like.

Similarly, the plurality of LIMS data 110-2 may include data from clinical LIMS, a pharmaceutical LIMS, biotechnology LIMS, forensic LIMS, environmental LIMS, food and beverage LIMS, and the like. Each of the plurality of LIMS data 110-2 may include data corresponding to managing samples, quality control related information of the samples, tracking of samples, analysis of samples, and the like. For instance, a food and beverage LIMS data may include data corresponding to food sample that the food and beverage industry processes, such as cookies, chips, and the like. The food and beverage LIMS data may include data corresponding to cookie sample, temperature for making cookie sample, time for making cookie sample, quality control related information of cookie samples, such as mixing speed and time and the like.

The plurality of QMS data 110-3 may include data from pharmaceutical QMS, medical devices QMS, aerospace QMS, manufacturing QMS, healthcare QMS, and the like. In addition, the plurality of QMS data 110-3 may include cloud-based QMS data or an on-premise QMS data. The plurality of QMS data 110-3 may include data about quality processes corresponding to the industry to ensure compliance and operational effectiveness. In other words, each QMS may include a set of policies, processes, and procedures that industries may have to adhere to ensure safe and effective products. For instance, a medical device QMS data may include data corresponding to design control of manufacturing of a Magnetic Resonance Imaging (MRI) equipment, supplier quality of supply of different parts for manufacturing the MRI equipment, and the like.

The plurality of track and trace systems data 110-4 may include data from pharmaceutical track and trace, logistics track and trace, aerospace track and trace, automotive track and trace, and the like. The plurality of track and trace systems data 110-4 may enable tracking of products in the entire supply chain of the products, from supplier to consumer. For instance, the plurality of track and trace systems data 110-4 may include data corresponding to track vehicles, loading units, shipments or products through the entire supply chain. For instance, the pharmaceutical track and trace data includes data corresponding to tracking of a drug, as the drug moves forward through the supply chain and traces backward to reveal supply of components of the drug, including name of suppliers of various components of the drugs, identification number of suppliers of various components of the drugs, and the like. In an example, miscellaneous data 110-5 may include data corresponding to various data related to Internet-of-Things (IoT) corresponding industries, IoT-sensors used in the industry, such as IoT-based lights, various equipment in the industry, such as controllers to control air-conditioners in the industry, and the like.

In an example, the system 100 may facilitate domain-based quality management. The system 100 may include a processing unit 102 and a memory 104. The processing unit 102 may include a microprocessor, a microcomputer, a microcontroller, a digital signal processor, a central processing unit, a state machine, a logic circuitry, or a device that manipulates signals based on operational instructions. Among other capabilities, the processing unit 102 may fetch and execute computer-readable instructions stored in the memory 104. The memory 104 may include a volatile memory or a non-volatile memory.

In addition, although not shown in FIG. 1, the system 100 may include a device (not shown in FIG. 1), such as a display device, for displaying various things, as will be explained later, corresponding to domain-based quality management. The display device may be, for example, a Light Emitting Diodes (LED) display, a Liquid Crystal Display (LCD), Thin Film Transistor Display, OLED (Organic Light Emitting Diode) Display, Capacitive Touch Screen, Resistive Touch Screen, mobile devices, such as a laptop, tablets, cell phones, and the like, with display, or a combination thereof.

The processing unit 102 may include an analysis model 106 generated by the processing unit 102. The processing unit 102 may use the analysis model 106 to perform various activities, as will be explained in detail later. In an example, using the analysis model 106, the processing unit 102 may generate a plurality of standardized domain-specific data frameworks 108. Each of the plurality of standardized domain-specific data frameworks 108 may correspond to a field of operation, such as an industry. For instance, a first set of standardized domain-specific data frameworks may correspond to a drug industry (drug MES). A second set of standardized domain-specific data frameworks may correspond to an aerospace industry (an aerospace MES). Each of the plurality of domain-specific data frameworks 108 may include a plurality of fields. The plurality of fields may be referred to hereinafter as the first plurality of fields. Each field of the first plurality of fields may correspond to a quality management parameter. For instance, a standardized domain-specific data framework for a drug manufacturing may include (ID, Name, Description, Drug_Class, temperature during formulation and mixing of drugs, pressure during compression and encapsulation of drugs, mixing speed for formulation, mixing time for formulation). Each of the plurality of standardized domain-specific data frameworks 108 may correspond to at least one of more components, 110-1 110-5, of the domain-based data 110. The generated plurality of standardized domain-specific data frameworks 108 may be stored in the memory 104.

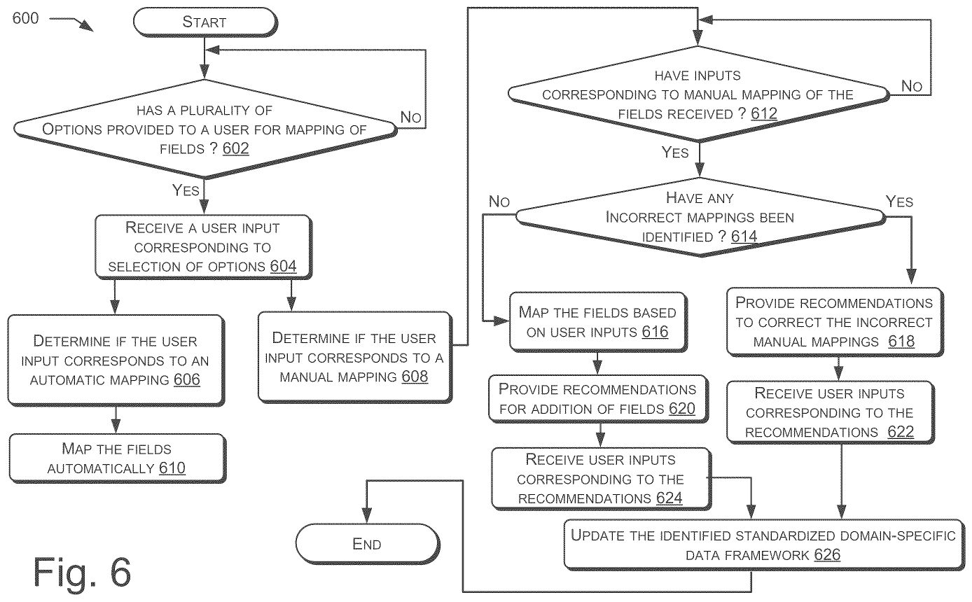

During operation, the system 100 may receive a domain-based data 110. The received domain-based data may include a plurality of fields. The plurality of fields may be referred to hereinafter as the second plurality of fields. Each of the second plurality of fields may correspond to a quality management parameter. For instance, a domain-based data for a drug manufacturing may include (Name, Drug_Class, temperature during formulation and mixing of drugs, pressure during compression and encapsulation of drugs). The system 100 may access the plurality of standardized domain-specific data frameworks 108 from the memory 104. The system 100 may process the received domain-based data and identify a corresponding standardized domain-specific data framework from out of the plurality of standardized domain-specific data frameworks 108 using the analysis model 106. In response to the identification, the system 100 may map each of a plurality of fields corresponding to the received domain-specific data with a corresponding field of the identified standardized domain-specific data. The mapping may be performed manually or automatically, as will be explained with reference to FIG. 6.

In response to the mapping, the system 100 may monitor critical quality control factors using the analysis model 106. The critical quality control factors may include measurable characteristics that impact quality corresponding to the domain-specific data. The critical quality control factors may include critical quality attributes (CQAs) and critical process parameters (CPPs) that impact product quality. CQAs are properties, such as physical, chemical, biological, or microbiological, and the like, or characteristics that should be within a predefined range, to ensure the desired product quality.

The CQAs may vary depending on the type of product and the industry. For example, in a pharmaceutical manufacturing, CQAs may include drug potency, drug concentration, dissolution rate of tablets or capsules, particle size distribution in a powdered drug, a microbial load in sterile products, content uniformity in multi-dose products. In a food and beverage MES, CQAs may include nutritional content (e.g., protein, fat, vitamins), texture attributes (e.g., hardness, crispiness, viscosity), microbiological safety (e.g., absence of pathogens), flavor profile and taste, shelf life, stability, and the like. In a semiconductor MES, CQAs may include dimensional accuracy of microelectronic components, resistivity or conductivity of semiconductor materials, particle contamination levels on wafers, electrical performance parameters (e.g., voltage, current), defect density, yield, and the like. In an automotive MES, CQAs may include dimensional accuracy and tolerance of components, mechanical strength and load-bearing capacity, surface finish and appearance, corrosion resistance, crash safety, impact resistance, and the like. In an Electronics MES, CQAs may include component lead alignment and solder joint integrity, electrical conductivity, signal integrity, Electromagnetic interference (EMI) and radio frequency interference (RFI) performance, environmental resistance (e.g., temperature, humidity), reliability, failure rates, and the like. In a Biotechnology and Biopharmaceutical MES, CQAs may include protein purity and impurities, biological activity and potency, Glycosylation patterns, molecular weight and aggregation state, protein folding and conformational stability.

The CPPs are variables or parameters that have a direct and significant impact on CQAs when varied within a predetermined range. For example, in a semiconductor manufacturing, the CPPs for creating circuit patterns in silicon wafers include exposure dose, humidity, and the like. In a pharmaceutical MES, CPPs may include temperature during formulation and mixing processes, pressure during compression and encapsulation of tablets, mixing speed and time during liquid formulation, drying temperature and time for granulation processes, pH level during chemical reactions, and the like. In a food and beverage MES, the CPPs may include temperature and humidity during fermentation processes, cooking temperature and time for baked goods, filling volume and pressure for beverages, cooling rate and temperature for certain food products, mixing speed and time for blending ingredients, and the like. In a semiconductor MES, the CPPs may include temperature and humidity during wafer fabrication processes, Chemical concentrations and flow rates during etching processes, film thickness and uniformity during deposition processes, exposure time and intensity during lithography processes, temperature and time during annealing or baking steps, and the like. In an automotive MES, temperature and pressure during molding and casting processes, torque and force during assembly operations, paint thickness and curing temperature during painting processes, welding parameters, such as current and voltage, during joining operations, and the like. In an electronics MES, the CPPs may include soldering temperature and dwell time during PCB assembly, reflow temperature profile during surface mount technology (SMT) processes, cleaning agent concentration and time during PCB cleaning, curing temperature and time for adhesives and encapsulants, and the like. In a Biotechnology and Biopharmaceutical MES, the CPPs may include temperature and agitation speed during cell culture processes, flow rates and pressure during chromatography purification steps, pH and dissolved oxygen levels during fermentation processes, concentration and temperature during protein formulation, and the like.

In response to the monitoring, the system 100 may generate alerts corresponding to the critical quality control factors. For instance, if there are any anomalies in the detected critical quality control factors, the system 100 may generate alerts. In addition, in some scenarios, the system 100 may generate notification to quality personnels that are involved in monitoring critical quality control factors irrespective of whether there are anomalies. Further, the system 100 may generate customized visualization. The visualization may include interactive dashboards may be dynamically updated based on real-time data. For instance, the interactive dashboards may include location-based suppliers of a drug composition, location-based sales of a drug, and the like. The generated alerts, customized visualizations, notifications may be displayed on the displayed device.

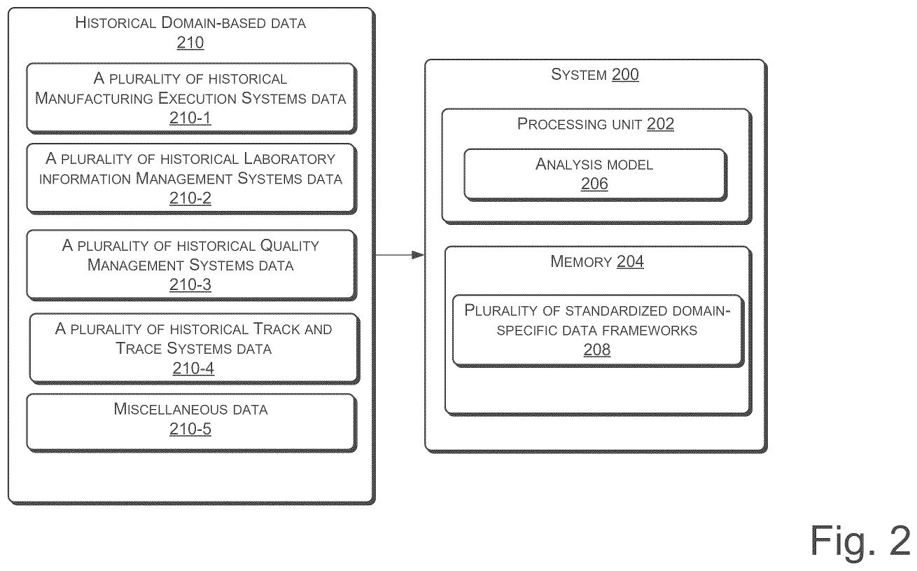

FIG. 2 illustrates a system 200 for domain-based quality management, according to an example implementation of the present subject matter. Herein, training of an analysis model 206 in the system 200 for domain-based quality management is depicted. In this regard, for the training, the system 200 may receive historical domain-based data 210. The historical domain-based data 210 may correspond to the domain-based data 110. Each of the historical domain-based data 210 may correspond to a field of operation, such as an industry. For instance, the historical domain-based data 210 may include pharmaceutical industry, aerospace industry, semiconductor industry, automotive industry, manufacturing industry, retail industry, healthcare industry, bio-technology industry, food and beverage industry, and the like. The historical domain-based data 210 may be collected at all stages of lifecycle of a product, such as supply, clinical research, manufacturing, and quality review and approvals. Accordingly, in an example, the historical domain-based data 210 may include a plurality of historical MES data 210-1, a plurality of historical LIMS data 210-2, a plurality of historical QMS data 210-3, a plurality of historical track and trace systems data 210-4, and historical miscellaneous data 210-5.

The historical domain-based data 210 may correspond to the domain-based data 110. The plurality of historical MES data 210-1 may correspond to the plurality of MES data 110-1, the plurality of historical LIMS data 210-2 may correspond to the plurality of LIMS data 110-2, the plurality of historical QMS data 210-3 may correspond to the plurality of QMS data 110-3, and the plurality of historical track and trace systems data 210-4 may correspond to the plurality of track and trace systems data 110-4. The historical miscellaneous data 210-5 may correspond to the miscellaneous data 110-5. For the sake of brevity, the components of the historical domain-based data 210 are not explained in detail. Each of the historical domain-based data 210 may include a plurality of attributes. Each of the plurality of attributes may correspond to quality management parameter. For instance, assume that a first set of the historical domain-specific data 210 may correspond to drug industry. In this regard, each of the first set of historical domain-specific data may include a name of the drug formulation, strength of the drug formulation, temperature during formulation, temperature during mixing processes, and the like.

During the training process, the analysis model 206 may identify common attributes across the historical domain-specific data 210 and may generate a plurality of standardized domain-specific data frameworks 208. For instance, assume that a set of historical domain-specific data 210 have been received by the system 200. Further, assume that the each of the set of historical domain-specific data 210 may correspond to a drug industry. Yet further, assume that a first historical domain-specific data may include attributes, such as a name of the drug formulation, strength of the drug formulation, composition of the drug formulation, and temperature during formulation and a second historical domain-specific data may include attributes, such as a name of the drug formulation, identity of the drug formulation, composition of the drug formulation, and temperature during formulation.

In this regard, the system 200 may identify using the analysis model 206 common attributes in the first historical domain-specific data and the second historical domain-specific data. In other words, the system 200 may identify name of the drug formulation, strength of the drug formulation, composition of the drug formulation, and temperature during formulation, as common attributes and generate a standardized domain-specific data framework. In other words, the generated standardized domain-specific data framework may include name of the drug formulation, strength of the drug formulation, composition of the drug formulation, and temperature during formulation. Likewise, the plurality of standardized domain-specific data framework 208 may be generated. Accordingly, each standardized domain-specific data frameworks 208 may include fields representing quality management parameters. The generated domain-specific data frameworks may be stored in a repository in the memory 204. The process of training the analysis model 206 will be explained in detail with reference to FIG. 6.

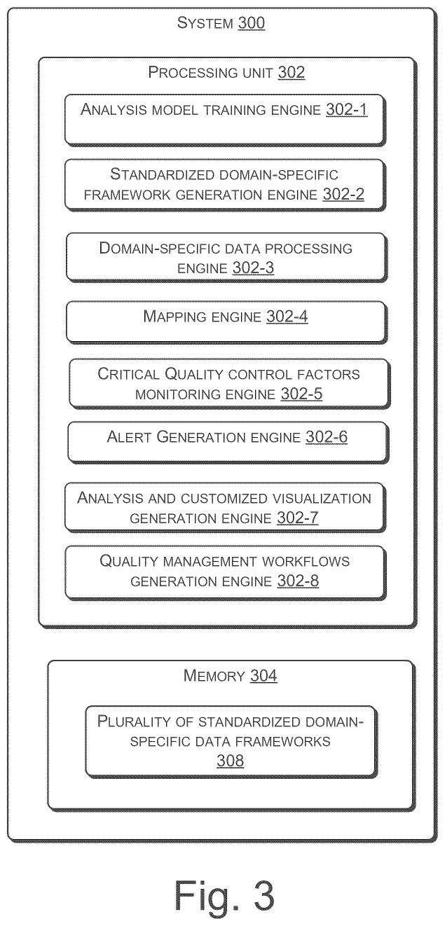

FIG. 3 illustrates a system 300 for domain-based quality management, according to an example implementation of the present subject matter. The system 300 may correspond to the system 100 or the system 200. The system 300 may be a computing device that has processing capabilities, such as a server, a desktop, a laptop, a tablet, a mobile phone, or the like. For instance, the system 300 may include a processing unit 302. The processing unit 302 may be, for example, a microprocessor, a microcomputer, a microcontroller, a digital signal processor, a central processing unit, a state machine, a logic circuitry, or a device that manipulates signals based on operational instructions. Among other capabilities, the processing unit 302 may fetch and execute computer-readable instructions stored in a memory (not shown in FIG. 3), such as a volatile memory or a non-volatile memory, of the system 300. The processing unit 302 may correspond to the processing unit 102 or the processing unit 202.

The processing unit 302 may run at least one operating system and other applications and services, such as a station health service. The system 300 can also include an interface (not shown in FIG. 3) and a memory 304. The processing unit 302, amongst other capabilities, may be configured to fetch and execute computer-readable instructions stored in the memory. The processing unit 302 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 302, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the cloud communication device to interact with different entities, such as the processing unit 302. Further, the interface may enable the components of the system 300 to communicate with other cloud servers, web servers, and external repositories. The interface may facilitate multiple communications within a wide variety of networks and protocol types, including wired network, wireless networks, wireless Local Area Network (WLAN), RAN, satellite-based network, and the like.

The memory 304 may be coupled to the processing unit 302 and may, among other capabilities, provide data and instructions for generating different requests. The memory 304 can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes. The memory 304 may include a plurality of standardized domain-specific data frameworks. Further, the system 300 may include a display device (not shown in FIG. 3). The display device may correspond to the display device of the system 100 or the display device of the system 200.

Further, the system 300 may include one or more engines 302-1-302-8. The engines 302-1-302-8 may include routines, programs, objects, components, data structures, and the like, which perform particular tasks or implement particular abstract data types. Further, the engines 302-1-302-8 may be implemented in hardware, instructions executed by a processing unit, or by a combination thereof.

In an implementation, the engines 302-1-302-8 may be machine-readable instructions which, when executed by the processing unit, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection.

The engines 302-1-302-8 may perform different functionalities. The engines 302-1-302-8 may include an analysis model training engine 302-1, a standardized domain-specific framework generation engine 302-2, a domain-specific data processing engine 302-3, a mapping engine 302-4, a critical quality control factors monitoring engine 302-5, an alert generation engine 302-6, an analysis and customized visualization generation engine 302-7, and quality management workflows generation engine 302-8.

The analysis model training engine 302-1 may train an analysis model on a plurality of historical domain-specific data. The analysis model may correspond to the analysis model 106 or the analysis model 206. For the training, the analysis model training engine 302-1 may identify common attributes corresponding to the plurality of historical domain-specific data. The plurality of historical domain-specific data may correspond to a plurality of historical domain-specific data 210. The standardized domain-specific framework generation engine 302-2 may generate the plurality of standardized domain-specific data framework 308 based on the training and using the analysis model, such as the analysis model 106, or the analysis model 206, as will be explained with reference to FIG. 6. The plurality of standardized domain-specific data frameworks 308 may correspond to the standardized domain-specific data frameworks 108 or the standardized domain-specific data frameworks 208. Each of the plurality of standardized domain-specific data framework 308 may correspond to a field of operation and may include a first plurality of fields. Each field of the first plurality of fields may correspond to a quality management parameter.

The domain-specific data processing engine 302-3 may process the domain-specific data received by the system 300 for the domain-based quality management. The processing may be performed by using the analysis model. For the processing, the domain-specific data processing engine 302-3 may extract metadata from the domain-specific data. The domain-specific data processing engine 302-3 may compare the extracted metadata with metadata corresponding to each of the plurality of domain-specific data frameworks 308. Further, the domain-specific data processing engine 302-3 may identify one of the plurality of standardized domain-specific data framework 308 that is correspond to the received domain-specific data based on the processing. In particular, the plurality of standardized domain-specific data framework 308 may identify that a standardized domain-specific data framework 308 corresponds to the received domain-specific data based on the comparison of the extracted metadata with the metadata of each of the plurality of domain-specific data frameworks 308. The comparison and the identification may be performed using the analysis model.

The mapping engine 302-4 may map, using the analysis model, a second plurality of fields of the received domain-specific data with a field of a first plurality of fields of the identified standardized domain-specific data framework. In an example, the mapping may be either automatic or manual. In an example, for the manual mapping, the mapping engine 302-4 may map each of the second plurality of fields of the domain-specific data with a field of the first plurality of fields of the identified standardized domain-specific data framework based on inputs from a user corresponding to manual mapping of each of the second plurality of fields.

Further, the mapping engine 302-4 may detect, using the analysis model, a field being mapped by the user based on the inputs and recommend, using the analysis model, a predefined domain-specific definition to the user in case of the mapping being not in accordance with the definition corresponding to the field. In other words, the mapping engine 302-4 may detect and provide recommendations to the user in case of incorrect mapping. In addition, the mapping engine 302-4 may also update the identified standardized domain-specific data framework based on the manual mapping.

In an example, in case of the manual mapping and/or automatic mapping, the mapping engine 302-4 may ascertain, using the analysis model, that at least one of the second plurality of fields does not correspond to each of the first plurality of fields based on the mapping. In such a scenario, the mapping engine 302-4 may update, using the analysis model, the identified standardized domain-specific data framework to include a custom field corresponding to the identified at least one of the second plurality of fields. In another example, in case of the manual mapping, the mapping engine 302-4 may update the identified standardized domain-specific data framework to include a custom field in response to a request from a user to add the custom field.

The critical quality factors monitoring engine 302-5 may monitor critical quality factors in response to the mapping. The critical quality factors may include measurable characteristics that impact quality corresponding to the domain-specific data. For the monitoring, the critical quality factors monitoring engine 302-5 may compare critical quality factors with a corresponding threshold using the analysis model. Based on the comparison, the anomalies or the absence thereof may be detected by the critical quality factors monitoring engine 302-5.

In an example, the critical quality control factors may include at least one Critical Process Parameter (CPP) and at least one critical Quality Attribute (CQA). In response to the monitoring, the critical quality control factors monitoring engine 302-5 may identify a threshold corresponding to the at least one CPP and a threshold corresponding to the at least one CQA. Further, the critical quality control factors monitoring engine 302-5 may compare the at least one CPP with the corresponding threshold and the at least one CQA with the corresponding threshold using the analysis model and may detect an anomaly based on the comparison.

The alert generation engine 302-6 may generate alert corresponding to the critical quality control factors using the analysis model. In an example, when an anomaly in the critical quality control factors is detected, the alert generation engine 302-6 may generate an alert. The alert may be sent as a notification to user. In an example, the alert generation engine 302-6 may also cause the alert to display on the display device.

The analysis and customized visualization generation engine 302-7 may generate customized visualization and predictive analytics to a user. The customized visualization may include interactive dashboards are dynamically updated based on real-time data. Further, the predictive analytics may provide insights and recommendations corresponding to the critical quality control factors corresponding to the domain-specific data. The analysis and customized visualization generation engine 302-7 may cause the predictive analytics and customized visualization to be displayed on the display device. The quality management workflows generation engine 302-8 may generate quality management workflows that may include update of electronic records in an integrated QMS corresponding to the domain-specific data in response to the monitoring and in response to the detection of the anomalies in the critical quality control factors. In another example, the quality management workflows generation engine 302-8 may generate quality management workflows in response to the absence of the detection of the anomalies in the critical quality control factors.

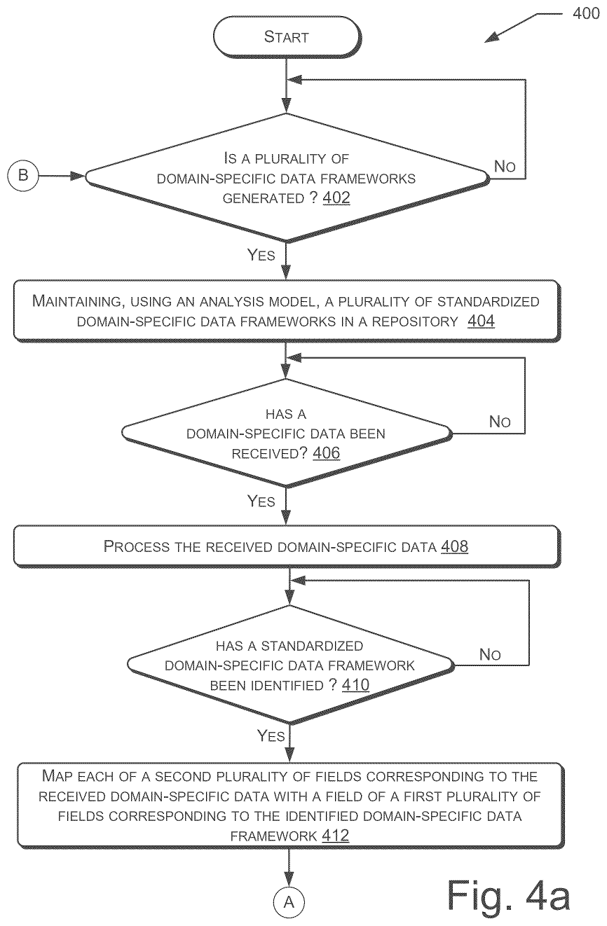

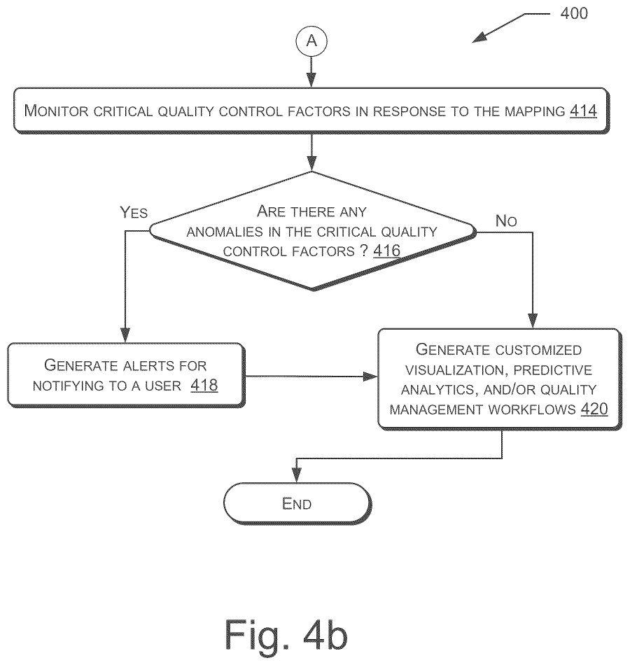

FIGS. 4a-4b illustrate a method 400 for domain-based quality management, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 400 may be performed by the system 100, the system 200 or the system 300. In particular, the method 400 may be performed by the processing unit 102, the processing unit 202, or the processing unit 302.

Referring to FIG. 4a, at step 402, it may be determined if a plurality of domain-specific data frameworks is generated. Each domain-specific data framework may correspond to a field of operation, such as an industry. For instance, each domain-specific data framework may correspond to pharmaceutical industry, aerospace industry, semiconductor industry, automotive industry, manufacturing industry, retail industry, healthcare industry, bio-technology industry, food and beverage industry, and the like. Each of the plurality of domain-specific data frameworks may include a first plurality of fields. Each field of the first plurality of fields may correspond to a quality management parameter. For instance, assume that the domain-specific data corresponds to a drug industry. The first plurality of fields may include name of the drug formulation, strength of the drug formulation, identity of the drug formulation, composition of the drug formulation, temperature during formulation, mixing processes involved in the drug formulation, pH level during chemical reactions during the during formulation, potency of the drug, dissolution rate of tablets, and the like. Each of the plurality of standardized domain-specific data frameworks may be updateable, as will be explained with reference to FIG. 6. The plurality of domain-specific data frameworks may correspond to the plurality of domain-specific data frameworks 108, the plurality of domain-specific data frameworks 208, or the plurality of domain-specific data frameworks 308. If, at step 402, it is determined that the plurality of domain-specific data frameworks is generated, the method 400 may move to the step 404. On the other hand, if it is determined that the plurality of domain-specific data frameworks is not generated, the method 400 may repeat the step 402.

At step 404, the plurality of standardized domain-specific data frameworks may be maintained in a repository. The repository may correspond to the repository in the memory 104, the memory 204, or the memory 304. At step 406, it may be determined if a domain-specific data has been received. The domain-specific data may be data corresponding to a user who wants to manage quality of their products. For instance, a drug company may want to manage quality of the products and may transmit a domain-specific data that has been used in their company for monitoring of the quality. The domain-specific data may include a second plurality of fields. Each of the second plurality of fields may correspond to a quality management parameter. The second plurality of fields may include identity of the drug formulation, drug formulation strength, ingredients of the drug formulation, temperature during formulation, pH level during chemical reactions during the during formulation, dissolution rate of tablets. The domain-specific data may be received from a domain-based data, such as the domain-based data 110.

At step 408, the received domain-specific data may be processed using an analysis model. The analysis model may correspond to the analysis model 106 or the analysis model 206. The analysis model may be a trained analysis model. In an example, the analysis model may be a machine learning model. In a particular example, the analysis model may be a Large Language Model (LLM).

For the processing, metadata corresponding to the received domain-specific data may be extracted. The extraction of the metadata may be performed by the analysis model. For instance, the analysis model may extract the metadata corresponding to the drug produced by the drug company. The drug company may stage the data corresponding to the drug produced at a shared location. The drug company may stage a subset of the domain-specific data in a lower test environment for the parsing and extracting of the metadata. Further, the extracted metadata may be compared with the metadata corresponding to the plurality of standardized domain-specific data frameworks. For instance, the analysis model may compare the metadata corresponding to the drug produced by the drug company with the metadata of each of the plurality of standardized domain-specific data frameworks.

At step 410, it may be determined if a standardized domain-specific data framework has been identified. Based on the comparison of the extracted meta data with the metadata of each of the plurality of domain-specific data framework. In particular, if the extracted metadata match with the metadata of a standardized domain-specific data framework, then the standardized domain-specific data framework may be identified as corresponding to the received domain-specific data. The identification of the standardized domain-specific data framework may be performed using analysis model. If, at step 410, it is determined that the standardized domain-specific data framework has been identified, the method 400 may proceed to step 412. On the other hand, if it is determined that the standardized domain-specific data framework has not been identified, the method 400 may repeat the step 410.

At step 412, each of the second plurality of fields corresponding to the received domain-specific data may be mapped with a field of a first plurality of fields corresponding to the identified domain-specific data framework. For instance, assume that the first plurality of fields corresponding to the identified domain-specific data framework may include name of the drug formulation, strength of the drug formulation, identity of the drug formulation, composition of the drug formulation, temperature during formulation, mixing processes involved in the drug formulation, pH level during chemical reactions during the during formulation, potency of the drug, and dissolution rate of tablets. Further, assume that the second plurality of fields may include identity of the drug formulation, drug formulation strength, ingredients of the drug formulation, temperature during formulation, pH level during chemical reactions during the during formulation, dissolution rate of tablets. In this regard, each of the second plurality of fields may be mapped with a field of the first plurality of fields. In other words, the identity of the drug formulation of the second plurality of fields may be mapped with the identity of the drug formulation of the first plurality of fields. Similarly, the strength of the drug formulation of the second plurality of fields may be mapped with the drug formulation strength of the first plurality of fields and so on. The mapping may be performed using the analysis model. In an example, the mapping may be performed automatically or manually, as will be explained with reference to FIG. 6.

Referring to FIG. 4b, at step 414, critical quality control factors may be monitored in real-time in response to the mapping. The critical quality control factors comprise measurable characteristics that impact quality corresponding to the domain-specific data. For the monitoring, the critical quality control factors may be identified in response to the mapping. Upon the identification of the critical quality control factors, real-time critical quality control factors may be compared with thresholds. In an example, the thresholds may be set by the user. In another examples, based on the industry-specific standard and based on the training, the analysis model may set the threshold automatically. In another example, in response to the automatic setting of the threshold, the user may be able to alter the threshold. The process of monitoring, the setting of the threshold, and the comparison with the threshold may be performed by using the analysis model.

In an example, the critical quality control factors may include critical quality attributes (CQAs) and critical process parameters (CPPs) that impact product quality. Accordingly, the CQAs and the CPPs may be monitored in real-time. In this regard, in response to the mapping, threshold corresponding to each of the CQAs and thresholds corresponding to each of the CPPs may be identified using the analysis model. As mentioned above, the thresholds may be set by the user, automatically set by using the analysis model based on the industry-specific definition or altered by the user in response to the automatic setting of the thresholds. For example, assume that the CQAs corresponding to the drug manufacturing may include drug concentration. The real-time drug concentration of the drug is 16 mg/5 mL. Further, assume that threshold of the drug concentration is 15 mg/5 mL. In this regard, the real-time drug concentration may be compared with the threshold for the monitoring of the CQA. Similarly, assume that the CPP may include temperature during formulation. Further, assume that real-time temperature during the formulation is 30° C. Yet further, assume that the threshold of the temperature during formulation is 40° C. In this regard, the real-time temperature during formulation may be compared with the threshold for the monitoring of the CPP.

At step 416, it may be detected if there are any anomalies in the critical quality control factors. The detection of anomalies may be performed by using the analysis model. For the detection of anomalies, it may be identified if the real-time critical quality control factors adhere to the threshold. If it is identified that the real-time critical quality control factors do not adhere to the corresponding threshold, the anomalies may be detected. On the other hand, if the real-time critical quality control factors adhere to the corresponding threshold, the absence of anomalies may be detected. The detection of the anomalies or the absence thereof may be detected by using the comparison, as mentioned in the step 414.

For example, upon the comparing of the real-time drug concentration (16 mg/5mL) with the corresponding threshold of the drug concentration (15 mg/5 mL), it may be detected that the real-time drug concentration is higher than the threshold. In other words, it may be identified that the CQA does not adhere to the threshold. Accordingly, anomaly in the drug concentration may be detected. Similarly, upon the comparing of the real-time temperature during the formulation (30° C.) and the threshold of the temperature during formulation (40° C.), it may be detected that the real-time temperature during formulation is lesser than the corresponding threshold. In other words, it may be identified that the CPP adheres to the corresponding threshold. Accordingly, absence of the anomaly in the temperature during formulation may be detected.

At step 416, if it is determined that there are any anomalies in the critical quality control factors, the method 400 may proceed to step 418. On the other hand, if it is determined that there are no anomalies (absence of anomalies), the method 400 may proceed to step 420. At step 418, alerts to notify the user may be generated by using the analysis model. The alerts may be displayed on the display device of the system, such as the display device of the system 100, the system 200, or the system 300. The alerts may be generated by using the analysis model. For instance, in response to identifying that the drug concentration does not adhere to the threshold, an alert may be generated and displayed to the user. The alert may indicate that the drug concentration is greater than the threshold. Further, upon performing the step 418, the method 400 may proceed to step 420.

At step 420, customized visualization, predictive analytics, and/or quality management workflows may be generated and displayed to the user. The generation and the display may be performed by using the analysis model. The customized visualizations may include interactive dashboards are dynamically updated based on real-time data. In an example, the dashboards may include visualization, such as graphics, graphs, metrics, and the like, corresponding to the critical quality control factors. For instance, the user may be able to see the drug composition of various drugs manufactured by the company, graph indicating supply of a drug based on geographies, location of suppliers, and the like. The dashboards may be interactive and may be able to provide visualization to data based on an input from a user. For instance, assume that the dashboard may include drug composition. The user may have to view drug supply based on geographies. In this regard, upon receiving inputs from the user on the same, the dashboard may provide visualization about the drug supply based on geographies.

In an example, the predictive analytics may include insights corresponding to the domain-specific data and critical quality control factors. The insights may, for example, include a prediction about a critical quality control factor may exceed the threshold, forecasting about the critical quality control factors based on techniques, such as regression analysis, multivariate statics, pattern matching, predictive modelling, and the like, insights about process followed in the manufacturing of the products, and the like.

The quality management workflows may include update of records in an integrated QMS corresponding to the domain-specific data. For instance, the critical process control factors may be updated in real-time in the QMS. In addition, the quality management workflows may also include recommendations to a quality person to correct the process parameters of manufacturing of the product to make the CPPs and/or the CQAs to adhere with the threshold. The recommendations may be displayed on the display device or sent to a mobile device of the quality person.

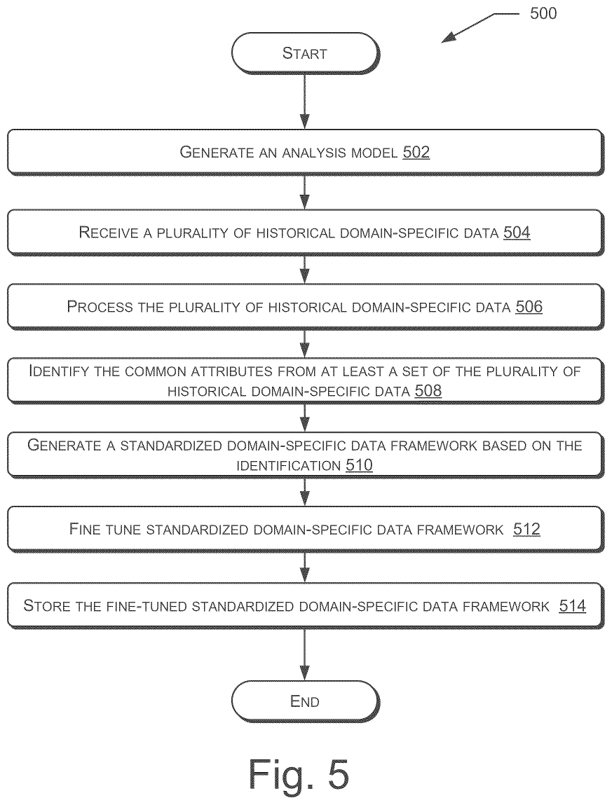

FIG. 5 illustrates a method 500 for domain-based quality management, according to an example implementation of the present subject matter. The order in which the method 500 is described is not intended to be construed as a limitation, and any number of the described method blocks may be combined in any order to implement the method 500, or an alternative method. Furthermore, the method 500 may be implemented by processor(s) or computing device(s) through any suitable hardware, non-transitory machine-readable instructions, or a combination thereof.

It may be understood that steps of the method 500 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 500 may be performed by the system 100, the system 200, or the system 300. In particular, the method 500 may be performed by the processing unit 102, the processing unit 202, or the processing unit 302. Herein, the training of the analysis model is explained.

Referring to FIG. 5, at step 502, an analysis model may be generated. The analysis model may correspond to the analysis model 106 or the analysis model 206. The analysis model may be a machine learning model. The analysis model may be trainable and updateable. At step 504, a plurality of historical domain-specific data. Each of the historical domain-based data may correspond to a field of operation, such as an industry. For instance, the historical domain-based data may include pharmaceutical industry, aerospace industry, semiconductor industry, automotive industry, manufacturing industry, retail industry, healthcare industry, bio-technology industry, food and beverage industry, and the like. The historical domain-based data may be collected at all stages of lifecycle of a product, such as supply, clinical research, manufacturing, and quality review and approvals. Accordingly, in an example, the historical domain-based data may include a plurality of historical MES data, a plurality of historical LIMS data, a plurality of historical QMS data, a plurality of historical track and trace systems data, and historical miscellaneous data. The plurality of historical domain-based data may correspond to the historical domain-based data 210.

Each of the plurality of historical domain-based data may include a plurality of attributes. Each attribute may correspond to a quality management parameter. For instance, in a drug manufacturing company, a first historical domain-based data may include attributes, such as name of the drug, classification of the drug, strength of the drug, temperature during formulation of the drug, drying temperature during granulation process, drug potency, particle size distribution. Similarly, a second historical domain-based data may include name of the drug, identity of the drug, strength of the drug, temperature during formulation of the drug, drying temperature during granulation process, drug potency, content uniformity in multi-dose products, and dissolution rate. In another example, in a food and beverage manufacturing industry, a plurality of historical domain-based data with a plurality of attributes may be received, and so on.

At step 506, the plurality of historical domain-specific data may be processed. For the processing, plurality of attributes corresponding to each of the plurality of historical domain-specific data may be extracted. For instance, the attributes corresponding to the first historical domain-based data and the attributes corresponding to the second historical domain-based data may be extracted. The step 506 may be performed by using the analysis model. At step 508, upon the processing, the common attributes from at least a set of the plurality of historical domain-specific data may be identified. The identification may be performed by using analysis model. For instance, upon the extraction of the attributes corresponding to each of the historical domain-specific data, the common attributes between the first historical domain-based data and the second historical domain-specific data may include attributes, such as name of the drug, classification of the drug, strength of the drug, temperature during formulation of the drug, drying temperature during granulation process, and drug potency.

At step 510, a standardized domain-specific data framework may be generated based on the identified common attributes. In particular, the identified common attributes may be formed as a plurality of fields for the standardized domain-specific data framework. For instance, the standardized domain-specific data framework may include fields, such as name of the drug, classification of the drug, strength of the drug, temperature during formulation of the drug, drying temperature during granulation process, and drug potency. Similarly, for each of the set of historical-domain specific data, common attributes may be identified and the corresponding standardized domain-specific data framework may be generated. In an example, for each industry, a plurality of standardized domain-specific data frameworks may be generated. In other words, the steps 508 to 510 may be repeated to generate the plurality of standardized domain-specific data frameworks. The step 510 may be performed by the analysis model.

At step 512, the standardized domain-specific data framework may be fine-tuned. For the fine-tuning, the analysis model may be used and may include Large Language Models (LLMs). The fine-tuning may include addition of fields to the standardized domain-specific data framework based on common industry knowledge in addition to the identified custom attributes. For instance, in the generated domain-specific data framework, dissolution rate is not identified since it is not part of common attributes. However, based on the industry knowledge, it may be determined that the dissolution rate is an important attribute. In this regard, based on the fine-tuning, the standardized domain-specific data framework may also be updated to include the dissolution rate as one of the fields. The step 512 may be performed for each of the plurality of standardized domain-specific data framework.

At step 514, the fine-tuned standardized domain-specific data framework may be stored in the repository, such as in the memory. The memory may correspond to the memory of the system 100, the system 200, or the system 300. Likewise, each of the fine-tuned standardized domain-specific data framework may be stored in the repository. The storing may be performed using the analysis model. The plurality of fine-tuned standardized domain-specific data frameworks may correspond to the plurality of standardized domain-specific data frameworks 108, the plurality of standardized domain-specific data frameworks 208, or the plurality of standardized domain-specific data frameworks 308.

FIG. 6 illustrates a method 600 for domain-based quality management, according to an example implementation of the present subject matter. The order in which the method 600 is described is not intended to be construed as a limitation, and any number of the described method blocks may be combined in any order to implement the method 600, or an alternative method. Furthermore, the method 600 may be implemented by processor(s) or computing device(s) through any suitable hardware, non-transitory machine-readable instructions, or a combination thereof.

It may be understood that steps of the method 600 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 600 may be performed by the system 100, the system 200, or the system 300. In particular, the method 600 may be performed by the processing unit 102, the processing unit 202, or the processing unit 302. In an example, the processing unit may use an analysis model to perform the method 600. The analysis model may correspond to the analysis model 106, the analysis model 206, or the analysis model 306. Herein, the mapping of the plurality of fields of the received domain-specific data with the fields of an identified standardized domain-specific data framework is discussed. In other words, step 412 of FIG. 4a is explained herein in detail. The identified standardized domain-specific data framework may be one of the plurality standardized domain-specific data frameworks, such as the plurality standardized domain-specific data frameworks 108, the plurality standardized domain-specific data frameworks 208, or the plurality standardized domain-specific data frameworks 308.

At step 602, it may be determined if a plurality of options is provided to a user for mapping of the fields of the domain-specific data. The options may be provided on a display device, such as the display device of the system 100, the display device of the system 200, or the display device of the system 300. The plurality of options may include automatic mapping of the fields of the domain-specific data and manual mapping of the fields of the domain-specific data. If, at step 602, the options are provided to the user, the method 600 may proceed to step 604. On the other hand, if it is determined that the options are not provided, the method 600 may await until the options are provided.

At step 604, the user inputs corresponding to the selection of options may be received. For instance, inputs corresponding to whether the user has selected automatic mapping, or the manual mapping may be received. At step 606, it may be determined if the user inputs correspond to the automatic mapping of the fields corresponding to the received domain-specific data. At step 608, it may be determined if the user inputs correspond to the manual mapping of the fields corresponding to the received domain-specific data.

At step 610, in response to the determination that the user input corresponds to the automatic mapping, the fields of the received domain-specific data (i.e., the second plurality of fields) may be mapped automatically to corresponding fields (i.e., the first plurality of fields) of the identified standardized domain-specific data framework that corresponds to the domain-specific data. For instance, assume that the second plurality of fields (fields of the received domain-specific data) may include name of the drug, classification of the drug, strength of the drug, temperature during formulation of the drug, drying temperature during granulation process, drug potency, and identity of the drug. Further, assume that the first plurality of fields (fields of the standardized domain-specific data framework) may include drug name, drug class, drug strength, temperature during formulation of the drug, drying temperature during granulation process, potency of the drug. In this regard, the name of the drug of the second plurality of fields may be mapped with drug name of the first plurality of fields, classification of the drug of the second plurality of fields may be mapped with the drug class of the first plurality of fields, strength of the drug of the second plurality of fields may be mapped with the drug strength of the first plurality of fields, and so on.

In addition, in an example, upon the automatic mapping, the method 600 may include receiving inputs from the user to add custom fields. For instance, the method 600 may provide user to add custom fields. The user may be able to add custom fields, such as identity of the drug. Based on the addition of the custom fields, the identified standardized domain-specific data framework may be updated.

Further, in response to the determination of manual mapping at step 608, the method may proceed to step 612. At step 612, it may be determined if the inputs corresponding manual mapping of the fields received. For instance, the manual mapping may include user inputs for mapping of each of the second plurality of fields with a field of the first plurality of fields. For example, the user may provide instructions to map the name of the drug of the second plurality of fields with drug name of the first plurality of fields, classification of the drug of the second plurality of fields with the drug class of the first plurality of fields, strength of the drug of the second plurality of fields with the drug strength of the first plurality of fields, and so on. If, at step 612, if the inputs corresponding to manual mapping are received, then the method 600 may move to step 614. On the other hand, if it is determined that the inputs are not received, the method 600 may repeat the step 612.

At step 614, it may be determined if there are any incorrect mappings. For instance, assume that the user has provided instructions to map identity of the drug of the second plurality of fields to the drug name of the first plurality of fields. The identity refers to a unique identification of the drug, which is different from the name of the drug. In this regard, it may be determined that the mapping is incorrect, at step 618, recommendations to correct the incorrect mappings may be provided to the user. For instance, recommendation to correct the mapping of the identity of the drug with the drug name to the name of the drug of the second plurality of fields with the drug name of the first plurality of fields. The recommendations may be provided on the display device.

On the other hand, at step 614, if it is determined that there are no incorrect mappings, then at step 616, the second plurality of fields may be mapped with a field of the first plurality of fields based on the user inputs. Further, from the step 616, the method 600 may proceed to step 620. At step 620, recommendations may be provided to add fields. For instance, assume that the second plurality of fields do not have pH level during chemical reactions. In this regard, recommendations to add the pH level during chemical reactions may be provided.

At step 624, user inputs may be received corresponding to the recommendations. The user inputs may be, for example, to add the recommended field or discard the recommendations. Subsequently, at step 626, the identified standardized domain-specific data framework may be updated. For instance, if the user inputs correspond to the addition of the field, the field may be retained in the identified standardized domain-specific data framework. In contrast, if the user indicates that the addition of field is not needed, the identified standardized domain-specific data framework may be updated without the addition of the recommended field.

Subsequent to step 618, the method 600 may perform the step 622. At step 622, user inputs corresponding to the recommendations at the step 618 may be received. For instance, the user inputs may include implementing the recommendations of the recommendations. For example, user inputs may include correction of the mapping of the identity of the drug with the drug name to the name of the drug with the drug name. In response to the receipt of the user inputs, at step 624, the identified standardized domain-specific data framework may be updated. For instance, the identified standardized domain-specific data framework may be updated with the correct mapping.

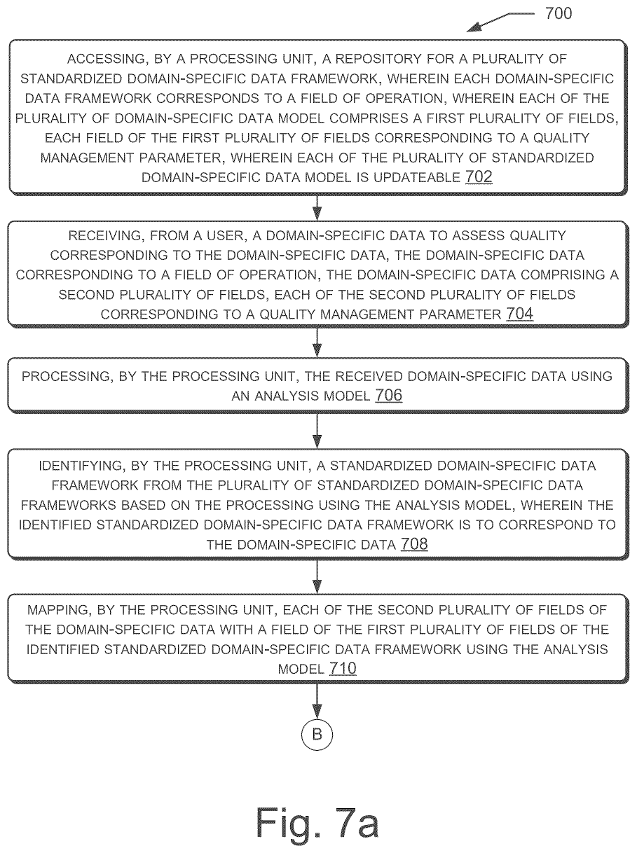

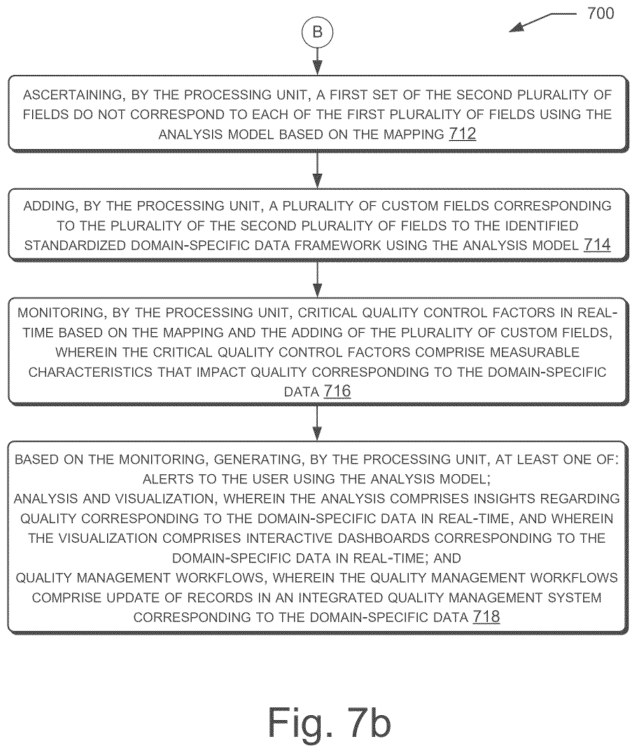

FIGS. 7a-7b illustrate a method 700 for domain-based quality management, according to an example implementation of the present subject matter. The order in which the method 700 is described is not intended to be construed as a limitation, and any number of the described method blocks may be combined in any order to implement the method 700, or an alternative method. Furthermore, the method 700 may be implemented by processor(s) or computing device(s) through any suitable hardware, non-transitory machine-readable instructions, or a combination thereof.

It may be understood that steps of the method 700 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 700 may be performed by the system 100, the system 200, or the system 300. In particular, the method 700 may be performed by the processing unit, such as the processing unit 102, the processing unit 202, or the processing unit 302. The method 700 may be performed by using the analysis model. The analysis model may correspond to the analysis model 106, the analysis model 206, or the analysis model 306.

Referring to FIG. 7a, at step 702, the method 700 may include accessing, by the processing unit, a repository for a plurality of standardized domain-specific data framework. Each domain-specific data framework may correspond to a field of operation. Each of the plurality of domain-specific data frameworks may include a first plurality of fields. Each field of the first plurality of fields may correspond to a quality management parameter. Each of the plurality of standardized domain-specific data frameworks may be updateable. The plurality of standardized domain-specific data framework may correspond to the plurality of standardized domain-specific data framework 108, the plurality of standardized domain-specific data framework 208, or the plurality of standardized domain-specific data framework 308.

At step 704, a domain-specific data may be received to assess quality corresponding to the domain-specific data. The domain-specific data may correspond to a field of operation. The domain-specific data may include a second plurality of fields. Each of the second plurality of fields may correspond to a quality management parameter. The domain-specific data may correspond to the domain-based data 110. At step 706, the received domain-specific data may be processed by the processing unit by using an analysis model. At step 708, a standardized domain-specific data framework from the plurality of standardized domain-specific data frameworks may be identified by the processing unit using the analysis model based on the processing. The identified standardized domain-specific data framework may correspond to the domain-specific data. At step 710, each of the second plurality of fields of the domain-specific data may be mapped, by the processing unit, with a field of the first plurality of fields of the identified standardized domain-specific data framework using the analysis model.

Referring to FIG. 4b, at step 712, a first set of the second plurality of fields that do not correspond to each of the first plurality of fields may be ascertained, by the processing unit, using the analysis model, based on the mapping. At step 714, the method 700 may include adding, by the processing unit, a plurality of custom fields corresponding to the plurality of the second plurality of fields to the identified standardized domain-specific data framework using the analysis model. At step 716, the method 700 may include monitoring, by the processing unit, critical quality control factors in real-time based on the mapping and the adding of the plurality of custom fields. The critical quality control factors may include measurable characteristics that impact quality corresponding to the domain-specific data. At step 718, based on the monitoring, alerts to the user using the analysis model, analysis and visualization, and/or quality management workflows may be generated by the processing unit. The analysis may include insights regarding quality corresponding to the domain-specific data in real-time. The visualization may include interactive dashboards corresponding to the domain-specific data in real-time. The quality management workflows may include update of records in an integrated quality management system corresponding to the domain-specific data.

In an example, for the monitoring of the critical quality control factors, the method 700 may include comparing, by the processing unit, critical quality control factors with a corresponding threshold using the analysis model. Further, anomalies in the critical quality control factors may be detected by the processing unit using the analysis model in response to the comparison. The alert to the user and the quality management workflows may be generated by the processing unit, in response to the detection of the anomalies.

In another example, for the monitoring of the critical quality control factors, the method 700 may include comparing, by the processing unit, critical quality control factors with a corresponding threshold using the analysis model. Absence of anomalies may be detected by the processing unit using the analysis model if the critical quality control factors adhere to corresponding threshold. The analysis and the visualization and the quality management workflows may be generated using the analysis model in response to the detection of absence of anomalies.

In an example, prior to the accessing of the plurality of standardized domain-specific data frameworks, the method 700 may include training, by the processing unit, the analysis model on a plurality of historical domain-specific data. Further, the plurality of standardized domain-specific data frameworks using the analysis model may be generated by the processing unit based on the training. The analysis model may identify common attributes across the plurality of historical domain-specific data for the generation. The plurality of standardized domain-specific data frameworks may be maintained in the repository upon the generation.

In another example, inputs corresponding to manual mapping of each of the second plurality of fields of the domain-specific data with a field of the first plurality of fields of the identified standardized domain-specific data framework may be received from the user. The received inputs may be analyzed, by the processing unit, using the analysis model. Each of the second plurality of fields of the domain-specific data may be mapped by the processing unit with a field of the first plurality of fields of the identified standardized domain-specific data framework based on the analysis.

Upon the analysis of the received inputs, the method 700 may include identifying, by the processing unit, that the received inputs include incorrect manual mappings of at least one of the second plurality of fields of the domain-specific data with a field of the first plurality of fields of the identified standardized domain-specific data framework. Recommendations to correct the incorrect manual mappings of the at least one of the second plurality of fields of the domain-specific data may be provided, by the processing unit, using the analysis model.

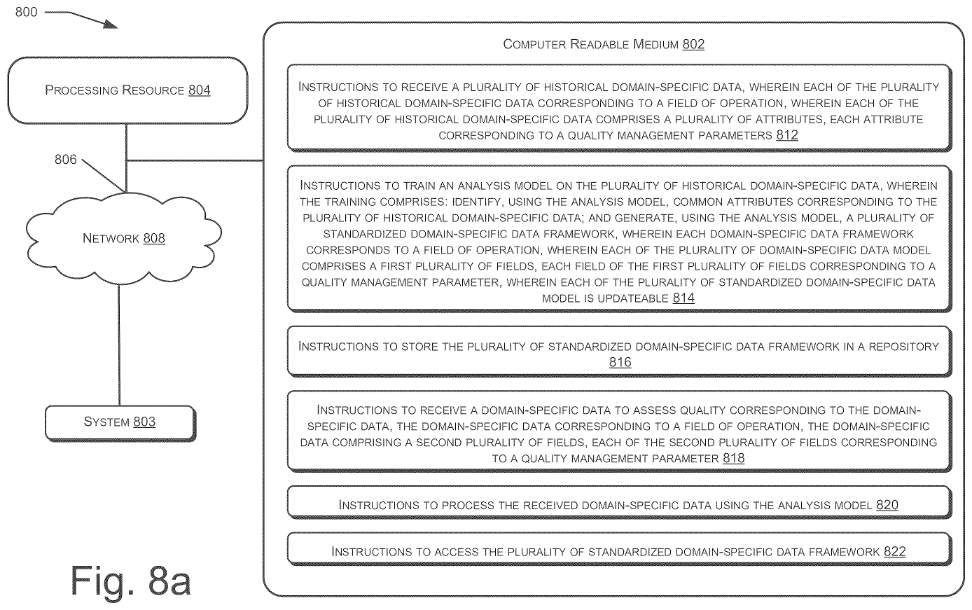

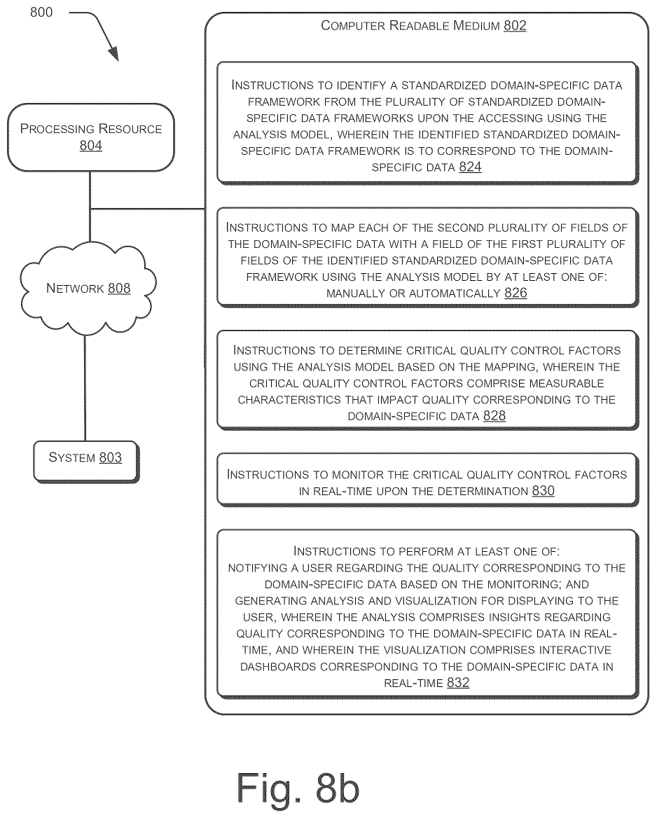

FIGS. 8a-8b illustrate a computing environment 800, implementing a non-transitory computer-readable medium for domain-based quality management, according to an example implementation of the present subject matter. In an example, the non-transitory computer-readable medium 802 may be utilized by the system 803. The system 803 may correspond to the system 100, the system 200, or the system 300. The system 803 may be implemented in a public networking environment or a private networking environment. In an example, the computing environment 800 may include a processing resource 804 communicatively coupled to the non-transitory computer-readable medium 802 through a communication link 806.

In an example, the processing resource 804 may be implemented in a device, such as the system 803. The processing resource 804 may correspond to the processing unit 102, the processing unit 202, or the processing unit 302. The non-transitory computer-readable medium 802 may be, for example, an internal memory device of the system 803 or an external memory device. The non-transitory computer-readable medium 802 may correspond to the memory 104, the memory 204, or the memory 304. In an implementation, the communication link 806 may be a direct communication link, such as any memory read/write interface. In another implementation, the communication link 806 may be an indirect communication link, such as a network interface. In such a case, the processing resource 804 may access the non-transitory computer-readable medium 802 through a network 808. The network 808 may be a single network or a combination of multiple networks and may use a variety of different communication protocols. The processing resource 804 and the non-transitory computer-readable medium 802 may also be communicatively coupled to the system 803 over the network 808.

In an example implementation, the non-transitory computer-readable medium 802 includes a set of computer-readable instructions for domain-based quality management. The set of computer-readable instructions can be accessed by the processing resource 804 through the communication link 806 and subsequently executed to perform acts for domain-based quality management.

Referring to FIG. 8a, in an example, the non-transitory computer-readable medium 802 includes instructions 812 to receive a plurality of historical domain-specific data. Each of the plurality of historical domain-specific data corresponding to a field of operation. Each of the plurality of historical domain-specific data may include a plurality of attributes. Each attribute may correspond to a quality management parameter. The plurality of historical domain-specific data may correspond to the plurality of historical domain-specific data 210.

The non-transitory computer-readable medium 802 includes instructions 814 to train the analysis model on the plurality of historical domain-specific data. The training may include identify, using the analysis model, common attributes corresponding to the plurality of historical domain-specific data. Further, a plurality of standardized domain-specific data framework may be generated using the analysis model. Each domain-specific data framework corresponds to a field of operation. Each of the plurality of domain-specific data frameworks may include a first plurality of fields. Each field of the first plurality of fields may correspond to a quality management parameter. Each of the plurality of standardized domain-specific data frameworks may be updateable. The plurality of standardized domain-specific data framework may correspond to the plurality of domain-specific data framework 108, the plurality of domain-specific data framework 208, or the plurality of domain-specific data framework 308.

The non-transitory computer-readable medium 802 includes instructions 816 to store the plurality of standardized domain-specific data framework in a repository. The non-transitory computer-readable medium 802 includes instructions 818 to receive a domain-specific data to assess quality corresponding to the domain-specific data. The domain-specific data may correspond to a field of operation. The domain-specific data may include a second plurality of fields. Each of the second plurality of fields may correspond to a quality management parameter. The domain-specific data may correspond to the domain-based data 110. The non-transitory computer-readable medium 802 includes instructions 820 to process the received domain-specific data using the analysis model. The non-transitory computer-readable medium 802 includes instructions 822 to access the plurality of standardized domain-specific data framework.

Referring to FIG. 8b, the non-transitory computer-readable medium 802 includes instructions 824 to identify a standardized domain-specific data framework from the plurality of standardized domain-specific data frameworks upon the accessing using the analysis model. The identified standardized domain-specific data framework may correspond to the domain-specific data.

The non-transitory computer-readable medium 802 includes instructions 826 to map each of the second plurality of fields of the domain-specific data with a field of the first plurality of fields of the identified standardized domain-specific data framework using the analysis model by at least one of: manually or automatically.

The non-transitory computer-readable medium 802 includes instructions 828 to determine critical quality control factors using the analysis model based on the mapping. The critical quality control factors may include measurable characteristics that impact quality corresponding to the domain-specific data.

The non-transitory computer-readable medium 802 includes instructions 830 to monitor the critical quality control factors in real-time upon the determination. Further, the non-transitory computer-readable medium 802 includes instructions 832 to perform notifying a user regarding the quality corresponding to the domain-specific data based on the monitoring, generation of the analysis and visualization for displaying to the user. The analysis may include insights regarding quality corresponding to the domain-specific data in real-time. The visualization may include interactive dashboards corresponding to the domain-specific data in real-time.

In an example, the critical quality control factors may include at least one Critical Process Parameter (CPP) and at least one critical Quality Attribute (CQA). The at least one CQA may correspond to a characteristic that is to be within a predetermined range to ensure desired quality of a product. The at least one CPP may correspond to a controllable variable that impacts the at least one CQA of the product. In response to the monitoring, the non-transitory computer-readable medium 802 includes instructions to identify a threshold corresponding to the at least one CPP and a threshold corresponding to the at least one CQA. The non-transitory computer-readable medium 802 includes instructions to compare the at least one CPP with the corresponding threshold and the at least one CQA with the corresponding threshold using the analysis model. The non-transitory computer-readable medium 802 includes instructions to detect an anomaly based on the comparison and notify the user corresponding to the domain-specific data in response to the detection.

The non-transitory computer-readable medium 802 includes instructions to extract metadata from the domain-specific data. Upon the accessing of the plurality of standardized domain-specific data, The non-transitory computer-readable medium 802 includes instructions to compare, using the analysis model, the extracted metadata with metadata corresponding to each of the plurality of domain-specific data framework. The non-transitory computer-readable medium 802 includes instructions to identify the standardized domain-specific data framework from the plurality of standardized domain-specific data frameworks using the analysis model in response to the comparison.

Prior to the monitoring of the critical quality control factors, the non-transitory computer-readable medium 802 includes instructions to ascertain, using the analysis model, at least one of the second plurality of fields does not correspond to each of the first plurality of fields based on the mapping. The non-transitory computer-readable medium 802 includes instructions to update, using the analysis model, the identified standardized domain-specific data framework to include a custom field corresponding to the identified at least one of the second plurality of fields.

With the present subject matter, standardized domain-specific data frameworks for various industries are generated. The various industries are, for examples, pharmaceutical industry, biotechnology industry, medical devices industry, healthcare industry, aerospace industry, forensic industry, retail industry, semiconductor industry, and the like. In the present subject matter, an analysis model that is updateable and that is trainable, is used. The present subject matter provides continuous learning from new data, improving the ability to detect anomalies using continuous process verification and predict quality issues over time. The present subject matter enables real-time monitoring of CPPs and CQAs and enables early detection of potential quality issues. Further, the present subject matter provides comprehensive alerts and notifications regarding quality issues. In addition, the present subject matter also provides predictive analytics regarding quality issues over time. Therefore, the present subject matter enables proactive quality management instead of reactive quality management and thereby preventing issues before they occur. Accordingly, with the present subject matter enables adopting QbD approach through continuous process verification. With the present subject matter, manual effort required for integration of data models is reduced. In other words, the present subject matter allows automatic mapping of customer's data models into the system. In addition, with the present subject matter, the option of manual addition of custom attributes to monitor quality parameters is also allowed. Therefore, the present subject matter provides user customization to monitor quality parameters. Further, the present subject matter provides recommendations to the user and enables the user to select appropriate attributes for mapping. The present subject matter provides a holistic view of quality across the product lifecycle, enabling better decision-making and continuous improvement.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for domain-based quality management, the system comprising:
a processing unit to:
maintain, using an analysis model, a plurality of standardized domain-specific data framework in a repository, wherein each domain-specific data framework corresponds to a field of operation, wherein each of the plurality of domain-specific data frameworks comprises a first plurality of fields, each field of the first plurality of fields corresponding to a quality management parameter, wherein each of the plurality of standardized domain-specific data frameworks is updateable;
receive a domain-specific data to assess quality corresponding to the domain-specific data, the domain-specific data corresponding to a field of operation, the domain-specific data comprising a second plurality of fields, each of the second plurality of fields corresponding to a quality management parameter;
process, using the analysis model, the received domain-specific data;
identify, using the analysis model, one of the plurality of standardized domain-specific data framework that is to correspond to the domain-specific data based on the processing;
map, using the analysis model, each of the second plurality of fields of the domain-specific data with a field of the first plurality of fields of the identified standardized domain-specific data framework;
monitor, using the analysis model, critical quality control factors in response to the mapping, wherein the critical quality control factors comprise measurable characteristics that impact quality corresponding to the domain-specific data;
generate, using the analysis model, alerts corresponding to the critical quality control factors in response to the monitoring; and
display customized visualizations and predictive analytics based on the monitoring, wherein the visualizations comprise interactive dashboards are dynamically updated based on real-time data.

2. The system of claim 1, wherein the processing unit is to:
detect, using the analysis model, anomalies based on the monitoring of the critical quality control factors; and
generate, using the analysis model, the alerts corresponding to the critical quality control factors in response to the detection.

3. The system of claim 1, wherein the processing unit is to:
provide, using the analysis model, recommendations corresponding to the domain-specific data for addition of fields to the second plurality of fields for the mapping to assess quality.

4. The system of claim 1, wherein the processing unit is to:
receive, from a user, inputs corresponding to manual mapping of each of the second plurality of fields of the domain-specific data with a field of the first plurality of fields of the identified standardized domain-specific data framework; and
map, using the analysis model, each of the second plurality of fields of the domain-specific data with a field of the first plurality of fields of the identified standardized domain-specific data framework based on the received inputs.

5. The system of claim 4, wherein the processing unit is to:
detect, using the analysis model, a field being mapped by the user based on the inputs; and
recommend, using the analysis model, a predefined domain-specific definition to the user in case of the mapping being not in accordance with the definition corresponding to the field.

6. The system of claim 1, wherein for the processing, the processing unit is to:
extract, using the analysis model, metadata from the domain-specific data; and
compare, using the analysis model, the extracted metadata with metadata corresponding to each of the plurality of domain-specific data framework.

7. The system of claim 1, wherein the analysis model is a machine-learning model, wherein the analysis model is trainable on a plurality of historical domain-specific data to build each of the plurality of standardized domain-specific data frameworks, wherein for the building, the analysis model is to identify common fields and attributes across the plurality of historical domain-specific data.

8. The system of claim 1, wherein prior to the monitoring of the critical quality control factors, the processing unit is to:
ascertain, using the analysis model, at least one of the second plurality of fields does not correspond to each of the first plurality of fields based on the mapping; and
update, using the analysis model, the identified standardized domain-specific data framework to include a custom field corresponding to the identified at least one of the second plurality of fields.

9. The system of claim 1, comprising:
receive, from a user, inputs corresponding to manual mapping of each of the second plurality of fields of the domain-specific data with a field of the first plurality of fields of the identified standardized domain-specific data framework;
map, using the analysis model, each of the second plurality of fields of the domain-specific data with a field of the first plurality of fields of the identified standardized domain-specific data framework based on the received inputs; and
update, using the analysis model, the standardized domain-specific data framework.

10. The system of claim 1, comprising:
receive, from a user, a request to add a custom field upon the mapping of the each of the second plurality of fields; and
update, using the analysis model, the identified standardized domain-specific data framework to include the custom field.

11. A method for domain-based quality management, the method comprising:
accessing, by a processing unit, a repository for a plurality of standardized domain-specific data framework, wherein each domain-specific data framework corresponds to a field of operation, wherein each of the plurality of domain-specific data frameworks comprises a first plurality of fields, each field of the first plurality of fields corresponding to a quality management parameter, wherein each of the plurality of standardized domain-specific data frameworks is updateable;
receiving, from a user, a domain-specific data to assess quality corresponding to the domain-specific data, the domain-specific data corresponding to a field of operation, the domain-specific data comprising a second plurality of fields, each of the second plurality of fields corresponding to a quality management parameter;
processing, by the processing unit, the received domain-specific data using an analysis model;
identifying, by the processing unit, a standardized domain-specific data framework from the plurality of standardized domain-specific data frameworks based on the processing using the analysis model, wherein the identified standardized domain-specific data framework is to correspond to the domain-specific data;
mapping, by the processing unit, each of the second plurality of fields of the domain-specific data with a field of the first plurality of fields of the identified standardized domain-specific data framework using the analysis model;
ascertaining, by the processing unit, a first set of the second plurality of fields do not correspond to each of the first plurality of fields using the analysis model based on the mapping;
adding, by the processing unit, a plurality of custom fields corresponding to the plurality of the second plurality of fields to the identified standardized domain-specific data framework using the analysis model;
monitoring, by the processing unit, critical quality control factors in real-time based on the mapping and the adding of the plurality of custom fields, wherein the critical quality control factors comprise measurable characteristics that impact quality corresponding to the domain-specific data; and
based on the monitoring, generating, by the processing unit, at least one of:
alerts to the user using the analysis model;
analysis and visualization, wherein the analysis comprises insights regarding quality corresponding to the domain-specific data in real-time, and wherein the visualization comprises interactive dashboards corresponding to the domain-specific data in real-time; and
quality management workflows, wherein the quality management workflows comprise update of records in an integrated quality management system corresponding to the domain-specific data.

12. The method of claim 11, wherein for the monitoring of the critical quality control factors, the method comprises:
comparing, by the processing unit, critical quality control factors with a corresponding threshold using the analysis model;
detecting, by the processing unit, anomalies in the critical quality control factors in response to the comparison using the analysis model; and
generating, by the processing unit, the alert to the user and the quality management workflows in response to the detection of the anomalies.

13. The method of claim 11, wherein for the monitoring of the critical quality control factors, the method comprises:
comparing, by the processing unit, critical quality control factors with a corresponding threshold using the analysis model;
detecting, by the processing unit, absence of anomalies using the analysis model if the critical quality control factors adhere to corresponding threshold; and
generating, by the processing unit, the analysis and the visualization and the quality management workflows using the analysis model in response to the detection of absence of anomalies.

14. The method of claim 11, wherein prior to the accessing of the plurality of standardized domain-specific data frameworks, the method comprises:
training, by the processing unit, the analysis model on a plurality of historical domain-specific data;
generating, by the processing unit, the plurality of standardized domain-specific data frameworks using the analysis model based on the training, wherein the analysis model is to identify common fields and attributes across the plurality of historical domain-specific data for the generation; and
maintaining, by the processing unit, the plurality of standardized domain-specific data frameworks in the repository upon the generation.

15. The method of claim 11, comprising:
receiving, from the user, inputs corresponding to manual mapping of each of the second plurality of fields of the domain-specific data with a field of the first plurality of fields of the identified standardized domain-specific data framework;
analyzing, by the processing unit, the received inputs using the analysis model; and
mapping, by the processing unit, each of the second plurality of fields of the domain-specific data with a field of the first plurality of fields of the identified standardized domain-specific data framework based on the analysis.

16. The method of claim 15, upon the analysis of the received inputs, the method comprises:
identifying, by the processing unit, that the received inputs include incorrect manual mappings of at least one of the second plurality of fields of the domain-specific data with a field of the first plurality of fields of the identified standardized domain-specific data framework; and
providing, by the processing unit, recommendations to correct the incorrect manual mappings of the at least one of the second plurality of fields of the domain-specific data using the analysis model.

17. A non-transitory computer-readable medium comprising instructions for domain-based quality management, the instructions being executable by a processing resource to:
receive a plurality of historical domain-specific data, wherein each of the plurality of historical domain-specific data corresponding to a field of operation, wherein each of the plurality of historical domain-specific data comprises a plurality of attributes, each attribute corresponding to a quality management parameters;
train an analysis model on the plurality of historical domain-specific data, wherein the training comprises:
identify, using the analysis model, common attributes corresponding to the plurality of historical domain-specific data; and
generate, using the analysis model, a plurality of standardized domain-specific data framework, wherein each domain-specific data framework corresponds to a field of operation, wherein each of the plurality of domain-specific data frameworks comprises a first plurality of fields, each field of the first plurality of fields corresponding to a quality management parameter, wherein each of the plurality of standardized domain-specific data frameworks is updateable;
store the plurality of standardized domain-specific data framework in a repository;
receive a domain-specific data to assess quality corresponding to the domain-specific data, the domain-specific data corresponding to a field of operation, the domain-specific data comprising a second plurality of fields, each of the second plurality of fields corresponding to a quality management parameter;
process the received domain-specific data using the analysis model;
access the plurality of standardized domain-specific data framework;
identify a standardized domain-specific data framework from the plurality of standardized domain-specific data frameworks upon the accessing using the analysis model, wherein the identified standardized domain-specific data framework is to correspond to the domain-specific data;
map each of the second plurality of fields of the domain-specific data with a field of the first plurality of fields of the identified standardized domain-specific data framework using the analysis model by at least one of: manually or automatically;
determine critical quality control factors using the analysis model based on the mapping, wherein the critical quality control factors comprise measurable characteristics that impact quality corresponding to the domain-specific data;
monitor the critical quality control factors in real-time upon the determination; and
perform at least one of:
notifying a user regarding the quality corresponding to the domain-specific data based on the monitoring; and
generating analysis and visualization for displaying to the user, wherein the analysis comprises insights regarding quality corresponding to the domain-specific data in real-time, and wherein the visualization comprises interactive dashboards corresponding to the domain-specific data in real-time.

18. The non-transitory computer-readable medium of claim 17, wherein the critical quality control factors comprise at least one Critical Process Parameter (CPP) and at least one critical Quality Attribute (CQA), wherein the at least one CQA corresponds to a characteristic that is to be within a predetermined range to ensure desired quality of a product, wherein the at least one CPP corresponds to a controllable variable that impacts the at least one CQA of the product, and wherein in response to the monitoring, the instructions are executable by the processing resource to:
identify a threshold corresponding to the at least one CPP and a threshold corresponding to the at least one CQA;
compare the at least one CPP with the corresponding threshold and the at least one CQA with the corresponding threshold using the analysis model;
detect an anomaly based on the comparison; and
notify the user corresponding to the domain-specific data in response to the detection.

19. The non-transitory computer-readable medium of claim 17, wherein for the processing of the plurality of domain-specific data, the instructions are executable by the processing resource to:
extract metadata from the domain-specific data, and wherein upon the accessing of the plurality of standardized domain-specific data, the instructions are executable by the processing resource to:
compare, using the analysis model, the extracted metadata with metadata corresponding to each of the plurality of domain-specific data framework; and
identify the standardized domain-specific data framework from the plurality of standardized domain-specific data frameworks using the analysis model in response to the comparison.

20. The non-transitory computer-readable medium of claim 17, wherein prior to the monitoring of the critical quality control factors, the instructions are executable by the processing resource to:
ascertain, using the analysis model, at least one of the second plurality of fields does not correspond to each of the first plurality of fields based on the mapping; and
update, using the analysis model, the identified standardized domain-specific data framework to include a custom field corresponding to the identified at least one of the second plurality of fields.
